(19) United States
(12) Patent Application Publication
(10) Pub. No.: US 2002/0117813 A1
(43) Pub. Date: Aug. 29, 2002

(54) Auxiliary mounting device for assembly and disassembly elements at locating pins and/or adjoining sleeves

(76) Inventors: Hans-Dieter Waltenberg, Staig (DE); Wolfgang Nikolaus, Ulm (DE); Armin Gutermann, Leipheim (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/015,437

(22) Filed: Dec. 13, 2001

(30) Foreign Application Priority Data
Dec. 19, 2000 (DE) 100 63 231.9

(51) Int. Cl. F16B 1/00

(52) U.S. Cl. 277/609

(57) ABSTRACT

The present invention pertains to an assembly aid for the assembly and disassembly of components to alignment pins and/or alignment sockets made from a base element with at least one recess that can engage the alignment pin, wherein the recess is configured in the base element such that in the installed state, at least two tangential contact regions are produced between the inner side of the base element and the alignment pin, and the inner side of the base element is formed as a flexible arm for at least one contact region.

The invention pertains to an assembly aid for the assembly and disassembly of a component that is to be attached to alignment pins and/or alignment sockets and that is made from a base element with at least one recess that can engage the alignment pin. In this way, at least one inner side of the base element is configured as a flexible arm for spring support of the alignment pin, which enables damage-free and long-term use of the alignment pins.

According to the prior art, assembly aids with a centering bushing with tooth-like structures on the inner side are used for the assembly of steel components. This enables the contact regions between the alignment pin and the tooth-shaped structures that are located at the inner side of the centering bushing and that are also referred to as holding tabs to provide an adjustment function.

EP 0 691 489 B1 and EP 0 691 490 A1 disclose metal laminate gaskets that feature interlocking and staggered boreholes such that the gasket is attached to a motor part so that it is fixed and cannot be reversed.

However, the disadvantage of said prior art is that it cannot prevent irreversible abrasive damage to the alignment pins over the long-term due to friction between the holding tabs and the alignment pin, which limits the service life of the alignment pins. This can be attributed to the fact that the tips of the holding tabs are aligned radially with respect to the alignment pin. Another disadvantage is that the radially aligned holding tabs exhibit no spring effect on the alignment pin, since these tabs have no flexibility.

Thus, the problem of the invention is to provide assembly aids for alignment pins and/or alignment sockets, which enable a long-term and damage-free assembly and disassembly of components to alignment pins and/or alignment sockets.

This problem is solved by the assembly aid according to the described art with the features of Claim 1. The additional subordinate claims demonstrate advantageous refinements.

According to the invention, there is an assembly aid made from a base element with at least one recess, wherein the recess is configured such that in the installed state, at least two tangential contact regions are produced between the inner side of the base element and the alignment pin. Alternatively, alignment sockets can be used instead of or also as a supplement to the alignment pins. Here, the phrase “installed state” means that the alignment pin is engaged in the recess. The base elements can be, e.g., plate-shaped or square-shaped bodies. In this way, the inner side of the base element is formed for at least one contact region as a flexible arm that is configured in width and strength to provide a spring effect on the alignment pin. The targeted selection of the strength and width of the arm enables the spring effect to be adjusted exactly for the alignment pin. With reference to this construction, it is now possible for the assembly and disassembly of components, in particular, multilayer steel gaskets (MLS), with respect to alignment pins to be done without any risk of damage. Due to the tangential contact regions between the inner side of the base element and the alignment pin, abrasive damage to the alignment pin is minimized, which significantly increases the service life of the pins. Simultaneously, the assembly and disassembly with respect to alignment pins is considerably simplified. Because abrasive wear on the inner side of the base element and on the alignment pins is prevented, the common assembly problem of components falling out of place can be prevented. In addition, considerable advantages for assembly and disassembly are realized, because these processes become easier to perform due to the use of devices according to the invention. Likewise, the device according to the invention now allows the components to be built up on a cover, which has great importance, e.g., for the assembly of metal gaskets to motor parts. This means that with the help of the assembly aid, motor parts covered by metal gaskets can be folded back.

For two contact regions between the inner side of the base element and the alignment pin, a loose support is formed, which allows for the adjustment of compensation of length.

Advantageously, the recess is configured such that there are at least three tangential contact regions between the alignment pin and the inner side of the base element, wherein at least one of the contact regions is supported with spring-like action by the arm.

In additional refinements, the arm can feature a break that is radial and/or tangential to the alignment pin and that can increase the spring effect of the arm on the alignment pin.

It is advantageous for the arm to be connected to the base element only at one end, so that the other end is free to pivot. This enables a particularly soft spring support of the alignment pin.

In an advantageous refinement, the arm extends along two adjacent sides of the recess. In this way, the arm can be guided around the recess, e.g., in the form of a curve. This further increases the flexibility of the arm, which also results in a softer spring effect on the alignment pin.

Preferably, the recess is shaped such that it can engage cylindrical alignment pins.

As a preferred material for the assembly aid, spring steel is used, which also enables advantageous production through stamping.

A few advantageous embodiments of the assembly aid are described with reference to the following figures.

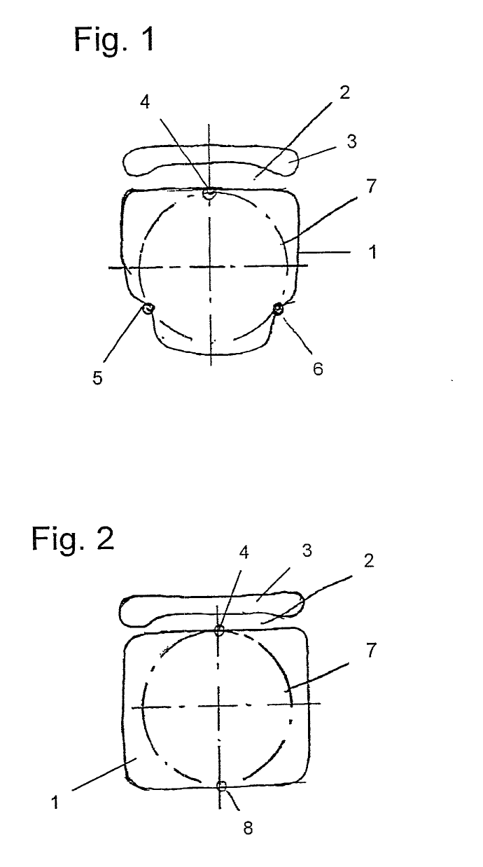

FIG. 1 shows a construction drawing of an assembly aid with three tangential contact regions between the inner side of the base element and the alignment pin. Between the two 3 recesses 1 and 3 there is an arm 2, whose width and material strength can be changed to adjust the spring effect on the alignment pin. The width of the arm 2 is thus determined by the distance between the two recesses. The alignment pin includes three contact regions with the inner side of the base element, the contact region 4 at the arm 2 and the two contact regions 5 and 6 on the side opposite the first contact region.

FIG. 2 shows the construction drawing of an assembly aid with two contact regions with the alignment pin, a contact region 4 directly on the arm 2, and another contact region 8 directly opposite. Likewise, it is possible for the arm 2 to have a radial or tangential break.

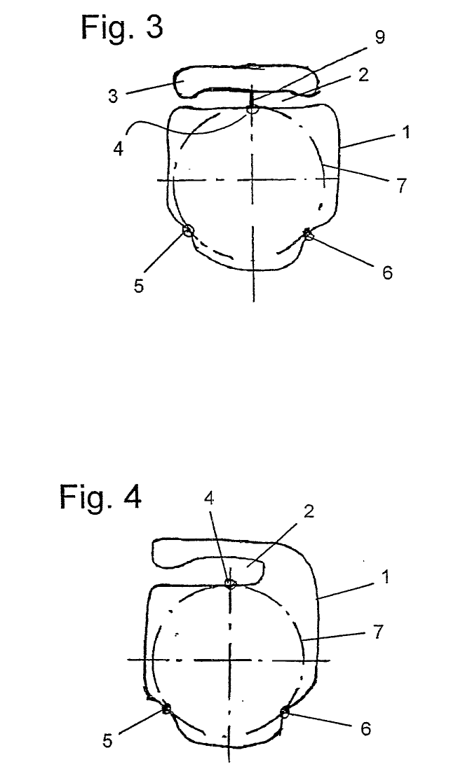

FIG. 3 shows an assembly aid for comparison with FIG. 1. Here, the arm 2 also features a radial break 9 that improves the spring effect of the arm 2.

FIG. 4 shows an assembly aid, in which the recess 1 is configured such that an arm 2 that can move freely on one side is formed. By means of this construction, the spring effect of the arm 2 on the alignment pin 7 can be increased. Here, the inner side of the base element contains three contact regions 4, 5, and 6, analogous to FIG. 1.

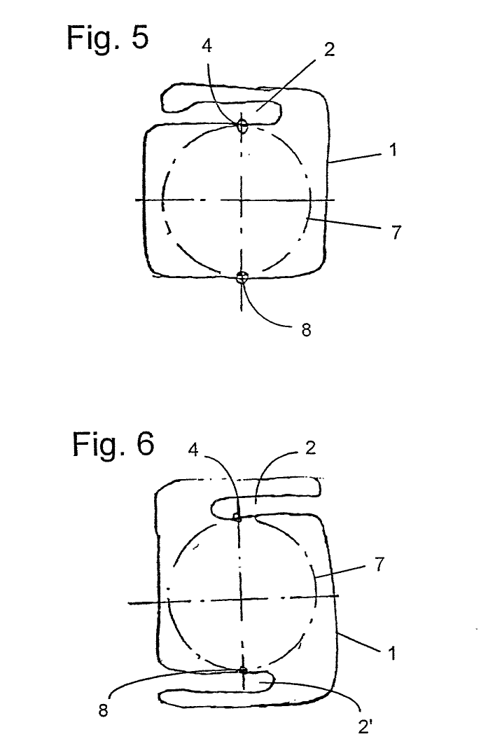

FIG. 5 shows an assembly aid like FIG. 4 for comparison. Here, the sole difference is that in this case there are two contact regions 4 and 8.

FIG. 6 shows the construction drawing of an assembly aid, in which the recess 1 is configured such that two arms 2 and 2′ that can each move freely on one side are formed. The inner side of the base element features three contact regions 4, 5, and 6 to the alignment pin.

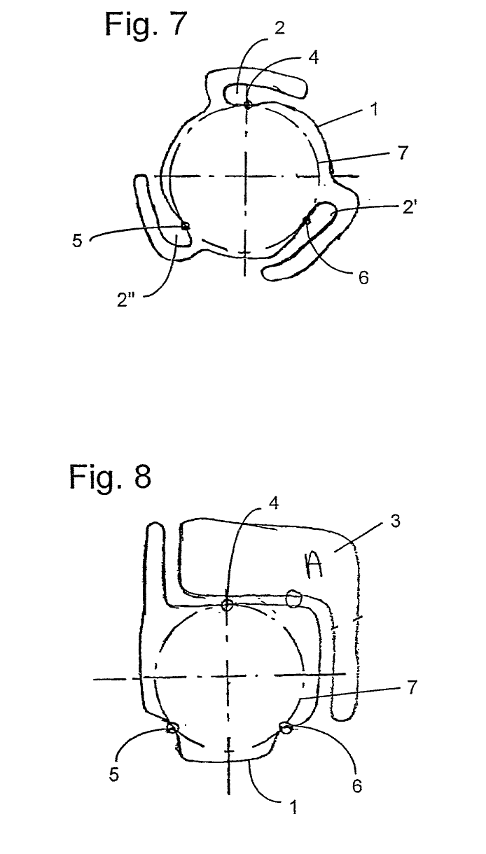

FIG. 7 shows the construction drawing of an assembly aid with three arms 2, 2′, and 2″ that can each move freely on one side. The assembly aid features two contact regions 4 and 8 to the alignment pin.

FIG. 8 shows the construction drawing of an assembly aid, in which the recesses 1 and 3 are configured such that an arm 2 is formed on two sides of the recess 1. By means of this geometry, the arm 2 achieves an especially soft spring support of the alignment pin 7. Likewise, the arm 2 can feature radial or tangential breaks at arbitrary positions.

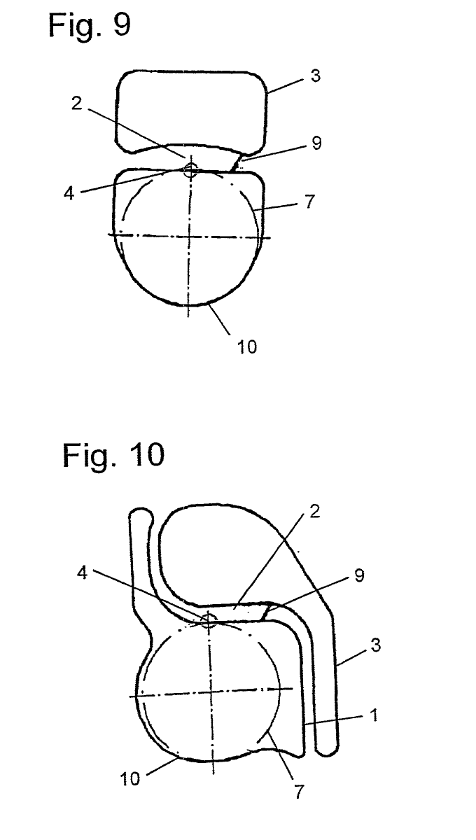

FIG. 9 shows a construction drawing illustrating an assembly aid for comparison with FIG. 2. Here, the recess 1 is configured such that at the side opposite the contact region 4, there is a long continuous contact region 10 that extends along the rear side of the alignment pin 7. In addition, the arm 2 features a break 9.

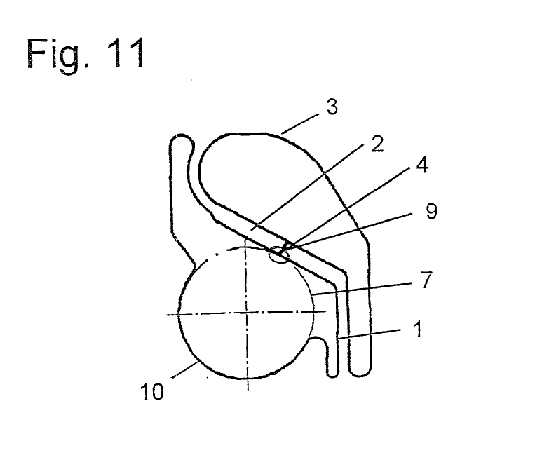

FIG. 10 shows a construction drawing of an assembly aid, in which the recesses 1 and 3 are configured such that an arm 2 is formed at two sides of the recess 1. Likewise, the arm 2 also features a radial break 9. Analogous to FIG. 11, the contact region 10 extends along the side opposite the contact region 4.

Analogous to FIG. 10, FIG. 11 shows an assembly aid with recesses 1 and 3 that are shaped such that an arm 2 featuring an angled branch is formed at two sides of the recess 1. The contact region 10 extends along the side opposite the contact region 4.

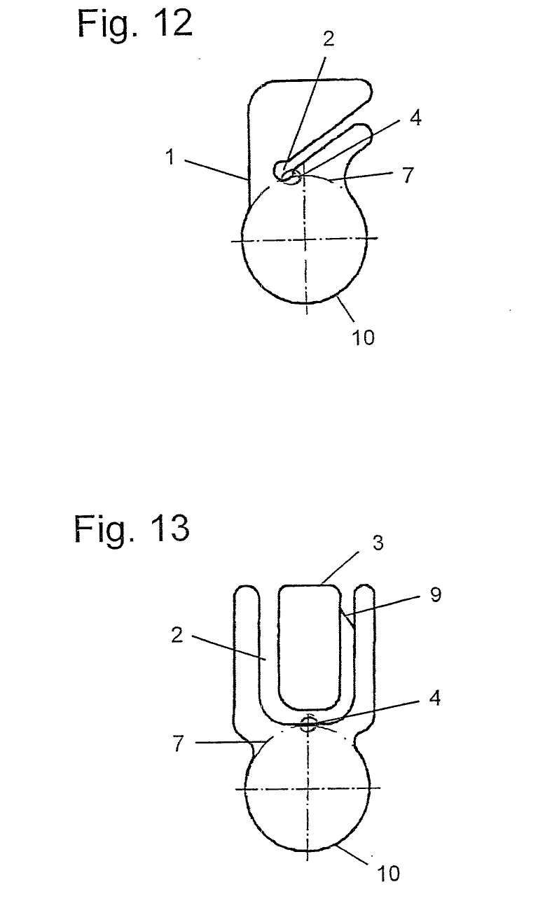

FIG. 12 shows a construction drawing of a device with an arm 2 that is punched at the tip in the form of a pinhead. The tip represents the contact region to the alignment pin. The contact region 10 extends along the side opposite the contact region 4. Here, there is also a single recess 1, whose shape forms the arm.

FIG. 13 shows the construction drawing of a device with a U-shaped arm 2. Thus, the contact region 4 to the alignment pin lies on the bottom side of the U-shaped arm 2. The contact region 10 is long and extends along the side opposite the contact region 4.

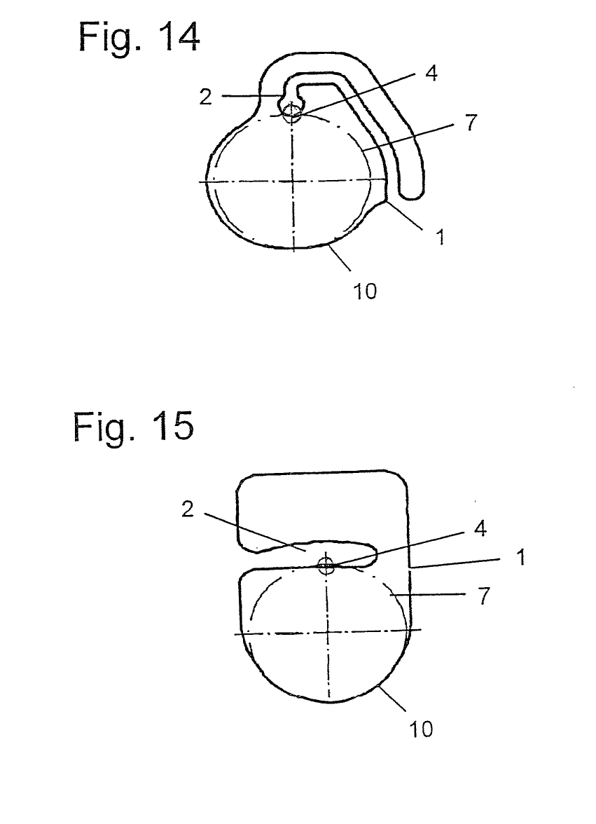

FIG. 14 shows a device, in which the tip of the arm is shaped like a pinhead, analogous to FIG. 12. Here, there is also a single recess 1, whose shape forms the arm.

FIG. 15 shows a device that features just one recess 1, analogous to the previous figure. The shape forms an arm 2 resulting in a contact region 4. On the side 10 opposite this region there is another continuous contact region 10.

1. Assembly aid for the assembly and disassembly of components with respect to alignment pins and/or alignment sockets made from a base element with at least one recess that can engage the alignment pin, characterized in that the recess (1) in the base element is configured such that in the installed state, at least two tangential contact regions are produced between the inner side of the base element and the alignment pin, and the inner side of the base element is formed as a flexible arm (2) for at least one contact region.

2. Assembly aid according to claim 1, characterized in that the recess (1) is configured such that there are at least three tangential contact surfaces to the alignment pin.

3. Assembly aid according to at least one of claim 1 or 2, characterized in that the arm (2) features a break that is radial with respect to the alignment pin (7).

4. Assembly aid according to at least one of claims 1-3, characterized in that the arm (2) features a break that is tangential to the alignment pin (7).

5. Assembly aid according to at least one of claims 1-4, characterized in that the arm (2) is only connected to the base element at one side.

6. Assembly aid according to at least one of claims 1-5, characterized in that the arm (2) extends along two adjacent sides of the recess (1).

7. Assembly aid according to at least one of claims 1-6, characterized in that the recess (1) is configured such that a cylindrical alignment pin (7) can be engaged in the recess.

8. Assembly aid according to at least one of claims 1-7, characterized in that the holding device is made from spring steel.

9. Assembly aid according to at least one of claims 1-8, characterized in that the recess is stamped out of the holding device.
